(19) United States
(12) Patent Application Publication
(10) Pub. No.: US 2010/0082409 A1
(43) Pub. Date: Apr. 1, 2010

(54) NABST market mechanism

(76) Inventor: Jason M. Badyrka, Houston, TX (US)

Correspondence Address: JASON M. BADYRKA, 15411 PLEASANT VALLEY RD., HOUSTON, TX, 77062-3607, US

(21) Appl. No.: 12/286,379

(22) Filed: Sep. 29, 2008

(51) Int. Cl. G06Q 30/00; G06Q 10/00; G06F 15/16; G06F 7/06

(52) U.S. Cl. 705/10; 705/26; 709/206; 709/202

(57) ABSTRACT

Enables self-serving consumer to indicate personal element of demand for a particular product so they are alerted to modified supply (promotion) for the product. Potential buyers use input in the form of MMS protocol or SMS protocol to communicate a proprietary code (identifying the store of product observation and a product of interest) to a communications host. The store and product information, together with a return address for responsive communications concerning the product, is stored in a third-party database. A seller interested in demand in their establishment could access the database and retrieve aggregate buyer-segmented product demand information for the consumer they target. The seller could effectively design incentive schemes and communicate promotional information by SMS protocol to the potential buyer via the communications host. The system is highly targeted, enhances economic communication of unsatisfied demand and delivers promotional supply information to self-targeted consumers with protection from unsolicited seller spam.

### CROSS-REFERENCE TO RELATED APPLICATIONS

| | | |
|---|---|---|
| Disclosure Document | 606960 | Establish Conception |
| Provisional Application | 60/852,235 | Reduction To Practice |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

As established the 2 of Oct. 2006 by means of Disclosure Document #606960. In preferred aspects, this invention relates to methods and systems for communicating economic information regarding unsatisfied demand and modified supply by means of a text messaging system.

Resource: The New Institutional Economics—Texas A&M University Press “The emphasis now is on enlarging the scope of standard microtheory by taking account of previously neglected features of the economic system. In order for an exchange between two parties, it is necessary that the two search each other out, which is costly in terms of time and resources. If the search is successful and the parties make contact they must inform each other of the exchange opportunity that may be present, and the conveying of such information will again require resources. If there is a potential bargain to be struck, some costs of decision making will be incurred before terms of a trade can be decided on. Then there is implementation and notification to the consumer.

The core problem of the economic organization of society is that of facing and dealing with uncertainty. Primary uncertainty is of a state contingent kind arising from random acts of nature and unpredictable changes in consumer preferences. The secondary uncertainty arises from ‘lack of communication’. Obviously prices do not vary at every moment which there is a change in the demand or supply, but what is the right interval for renegotiation or change in price? The supplier is prepared, indeed desires to make future revisions that both parties would have agreed to if the true state of demand and supply were readily known. If appropriate decisions are to be taken, suppliers must not only have access to certain types of strategic information but have confidence the information received is reliable. The absence of reliable information in the system tends to prevent the attainment of a superior allocative solution. Given this understanding, the next step is to explore some new arrangements designed to overcome the information problem and reduce allocative inefficiencies.

The group incentive mechanism typically assumes that suppliers are unable to foresee the characteristics or the thought process of the consumer whom they target. This inability leads to complications in the design of incentive schemes. However in reality, it is often not the case that consumer demands are really unobservable; rather, they may be very costly to observe. One may choose to model high-costs actions as being infeasible actions, but in doing so, one may miss some interesting phenomena. Simply because information gathering is traditionally costly for suppliers does not mean it is costly to everyone. With the right incentive the self-serving consumer is in the perfect position to help monitor themselves. Information suppliers want can be enticed from self-serving man with a reward for participation.”—Paraphrased For Emphasis—

### DESCRIPTION OF PRIOR ART

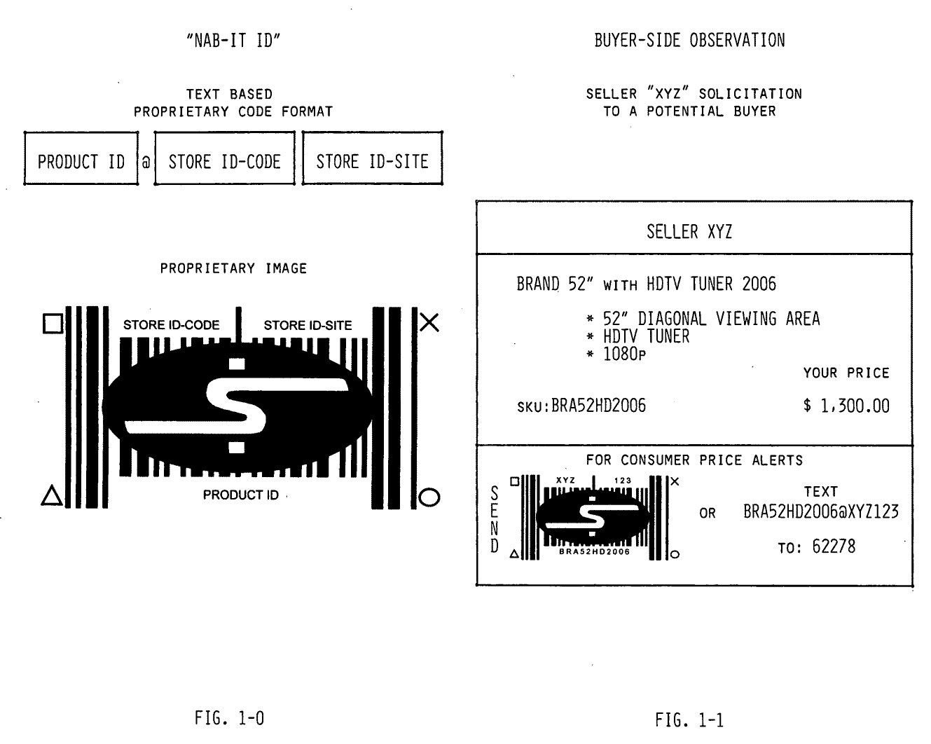

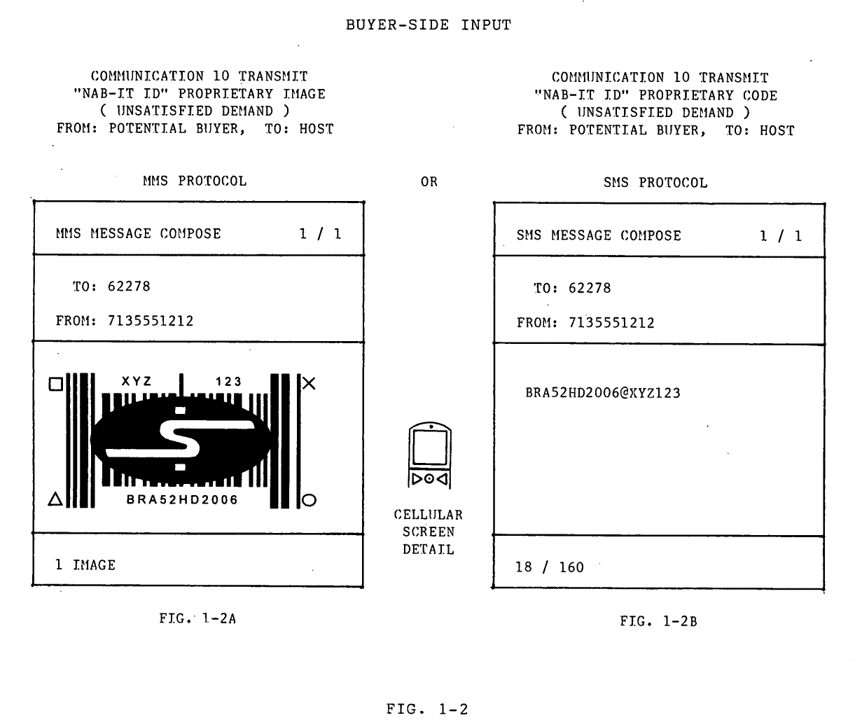

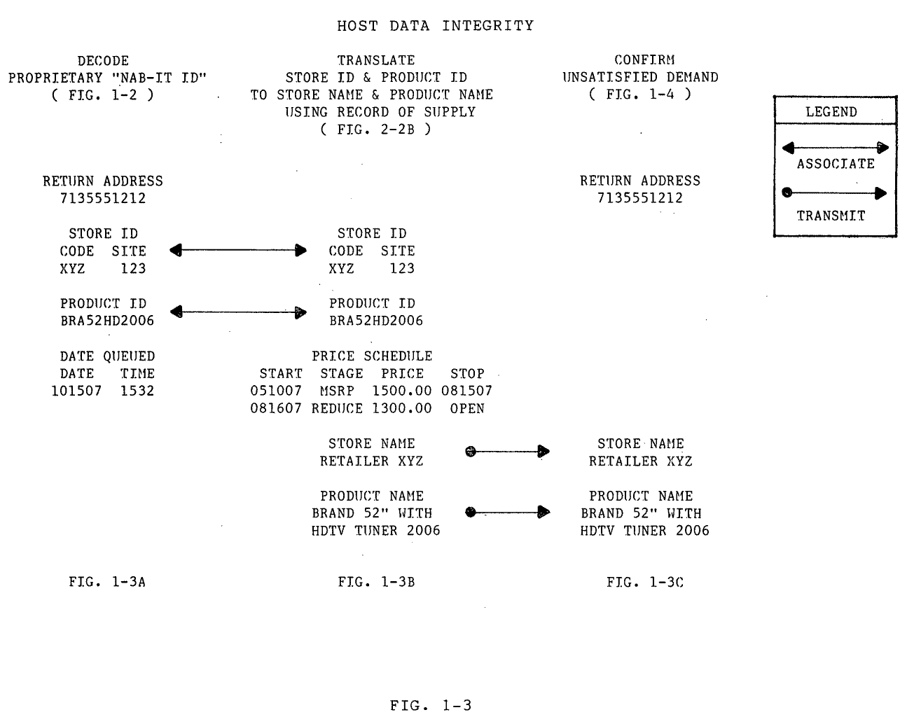

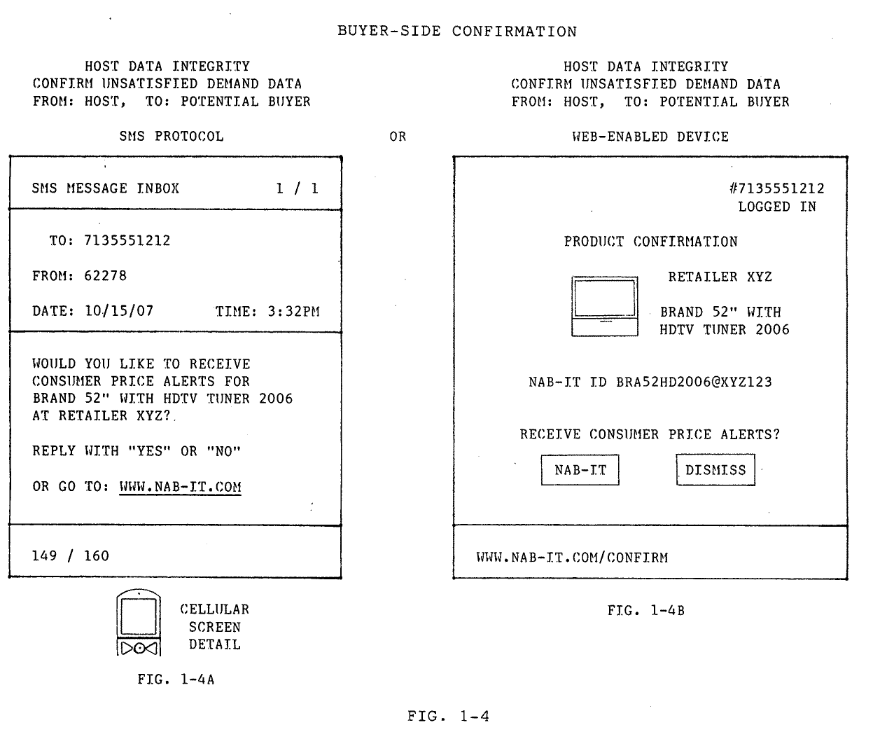

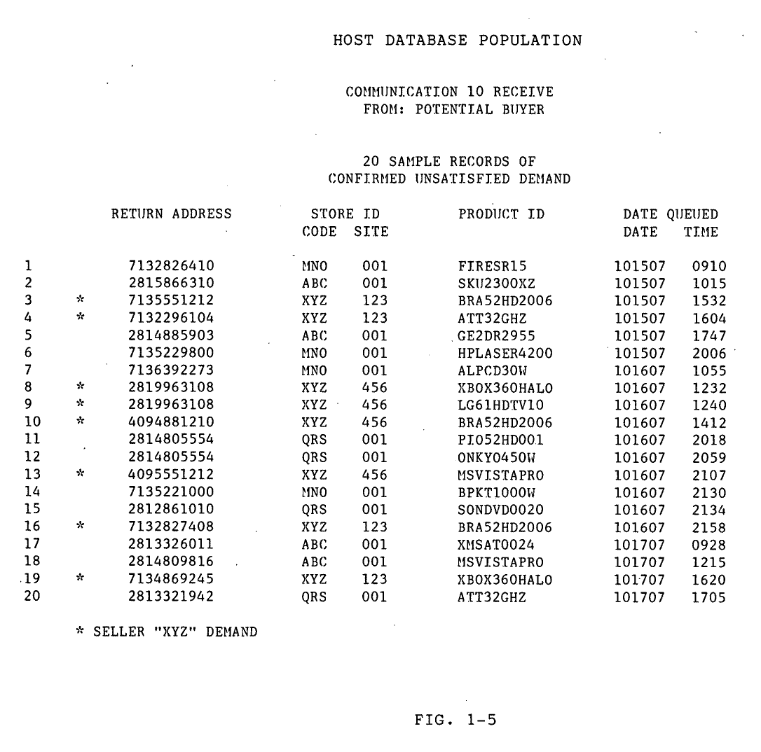

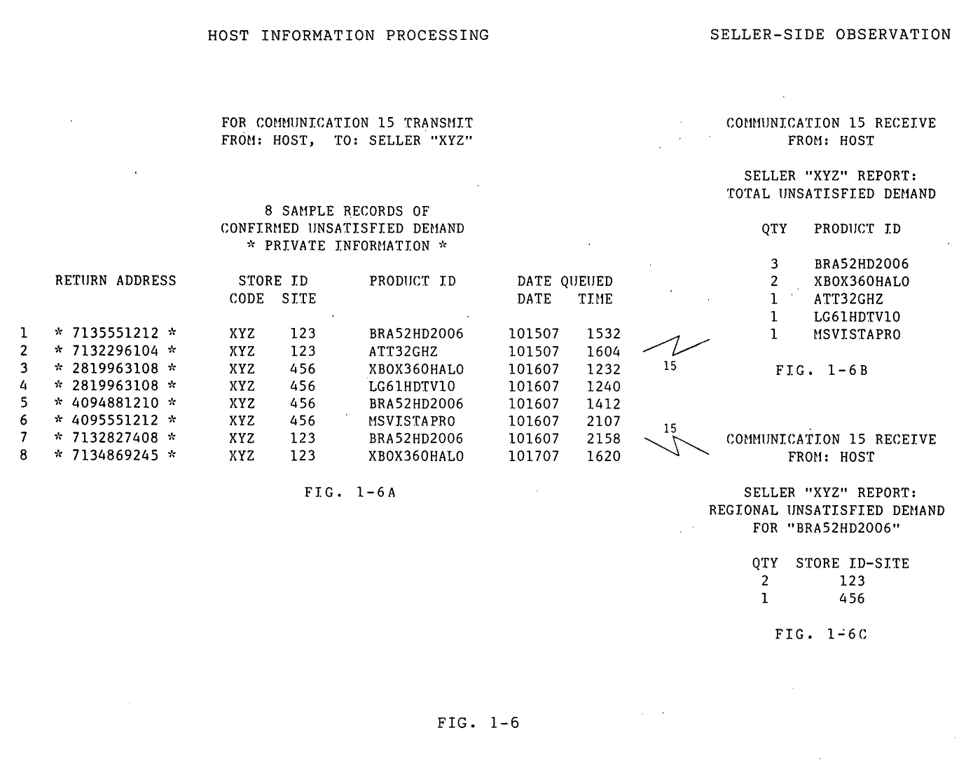

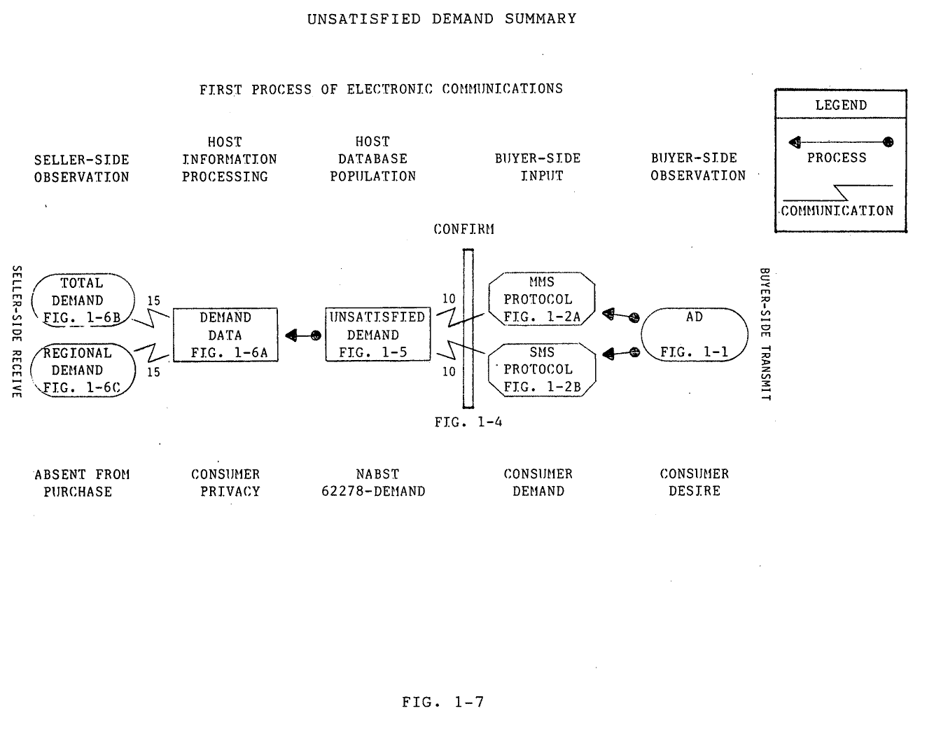

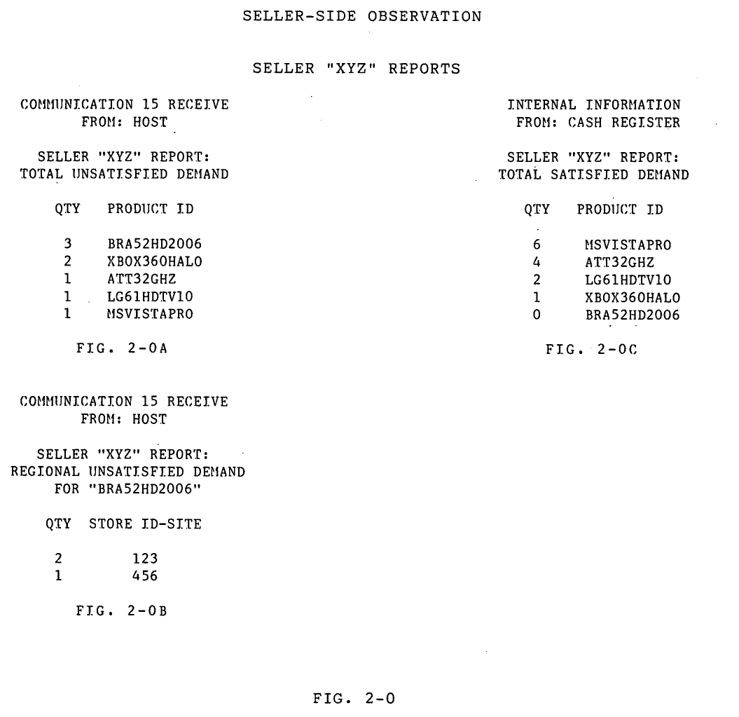

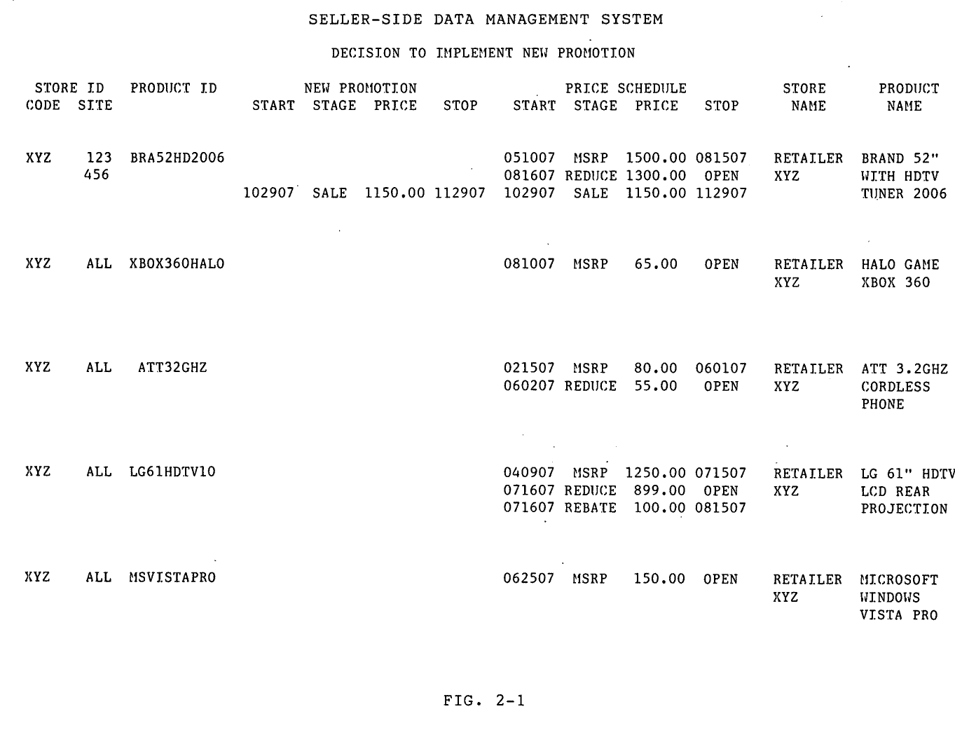

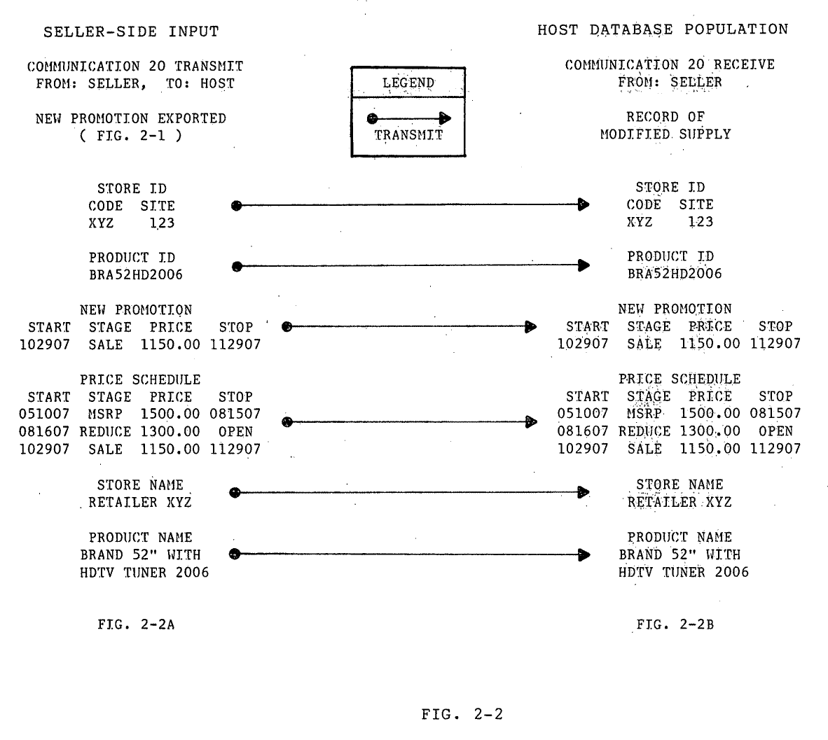

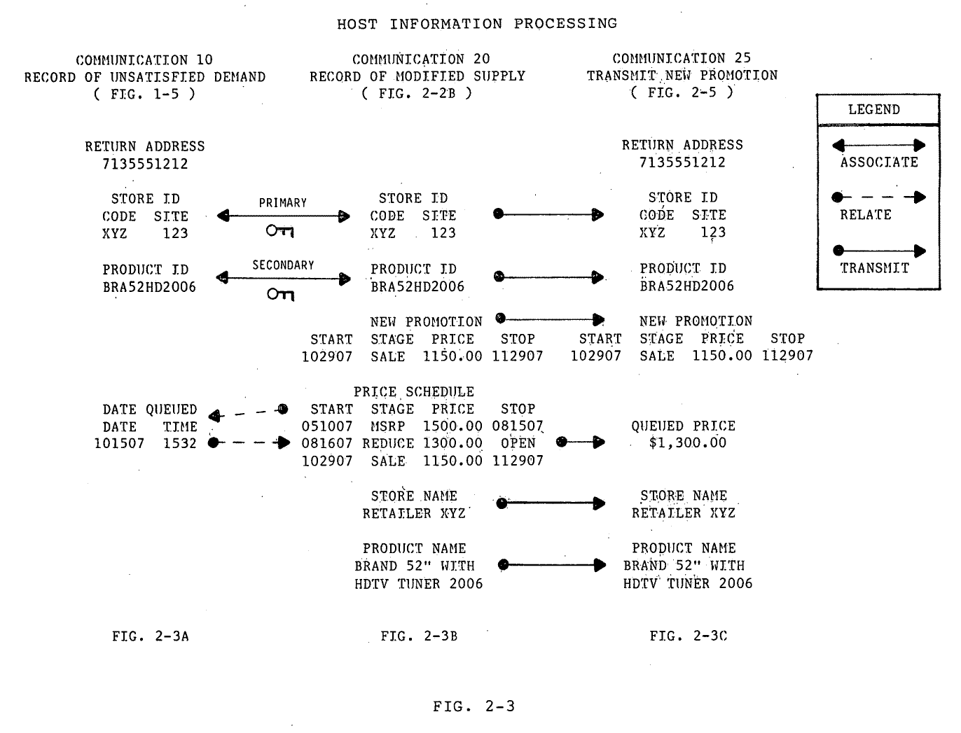

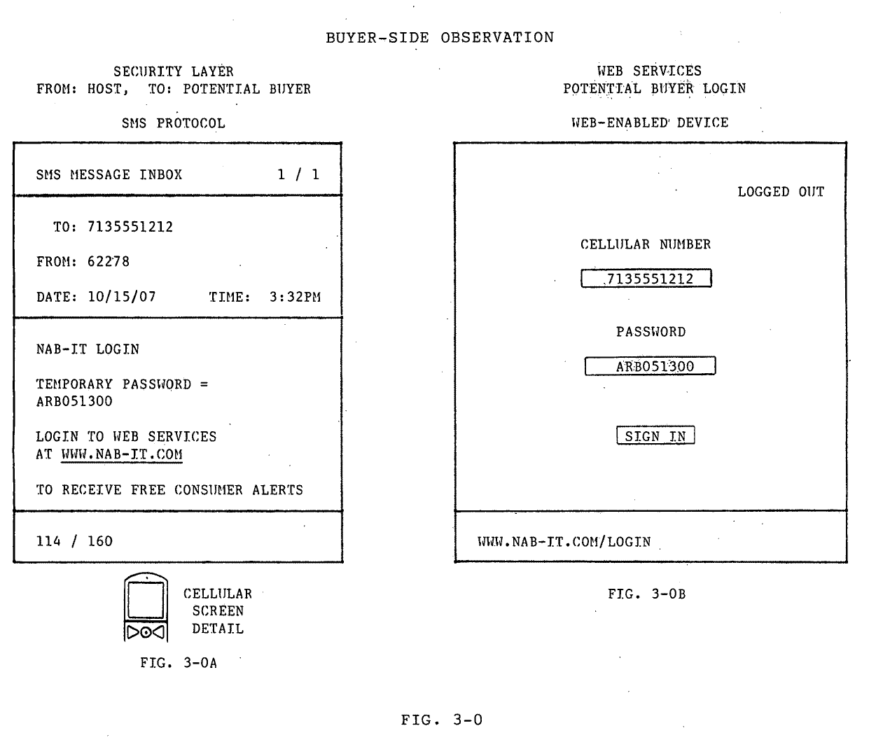

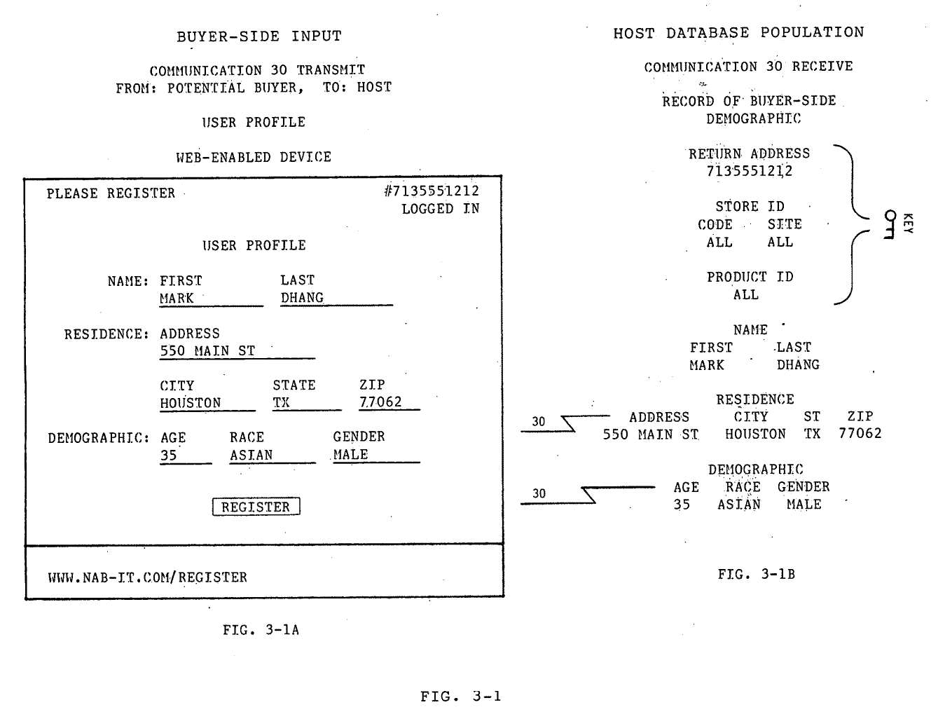

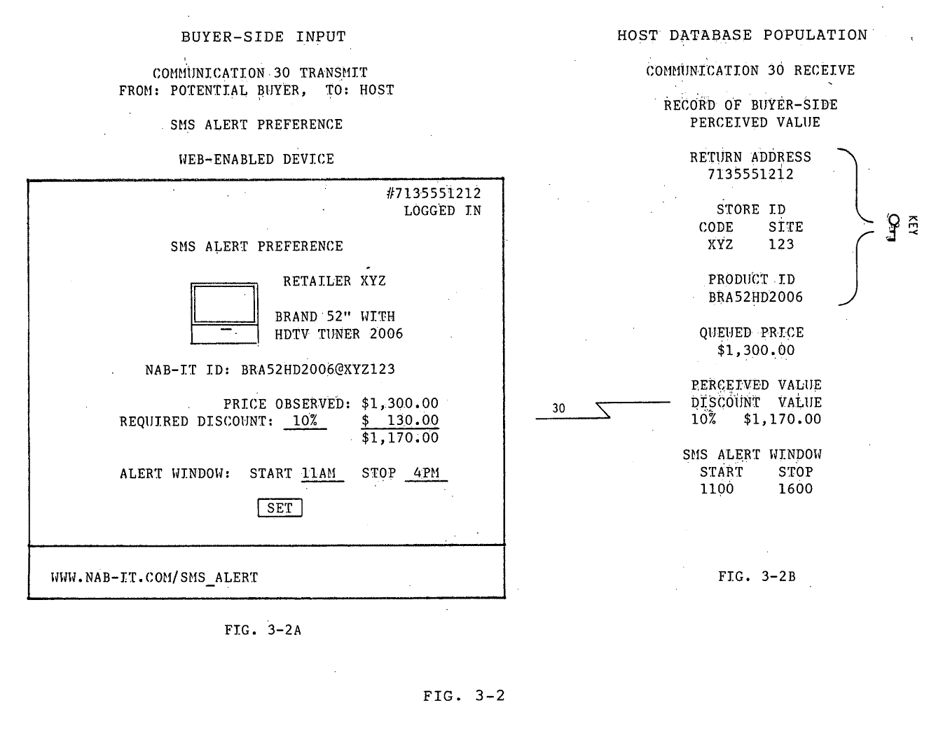

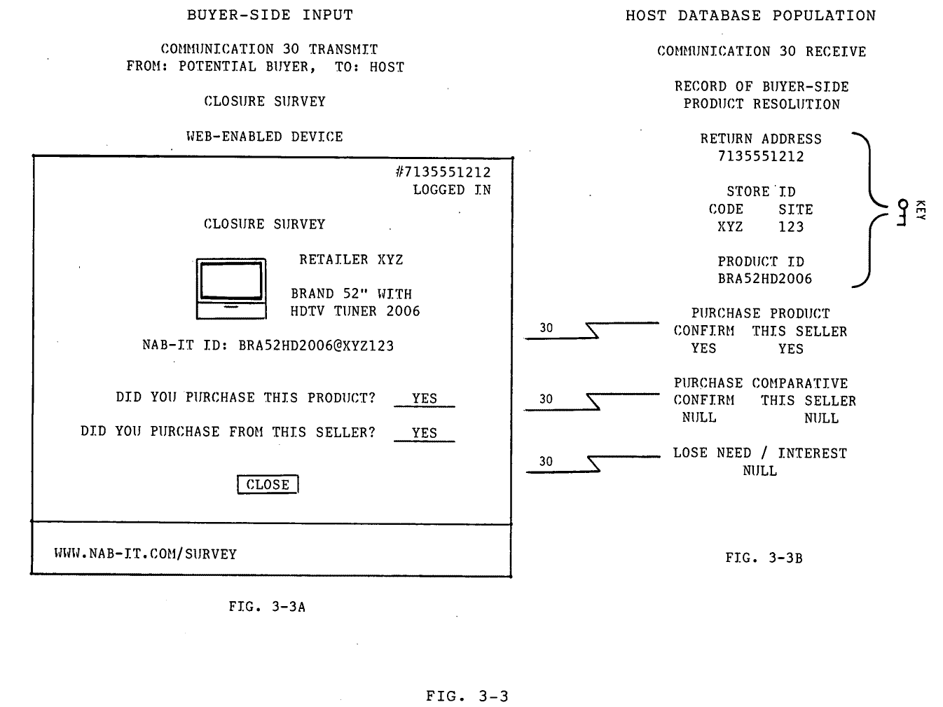

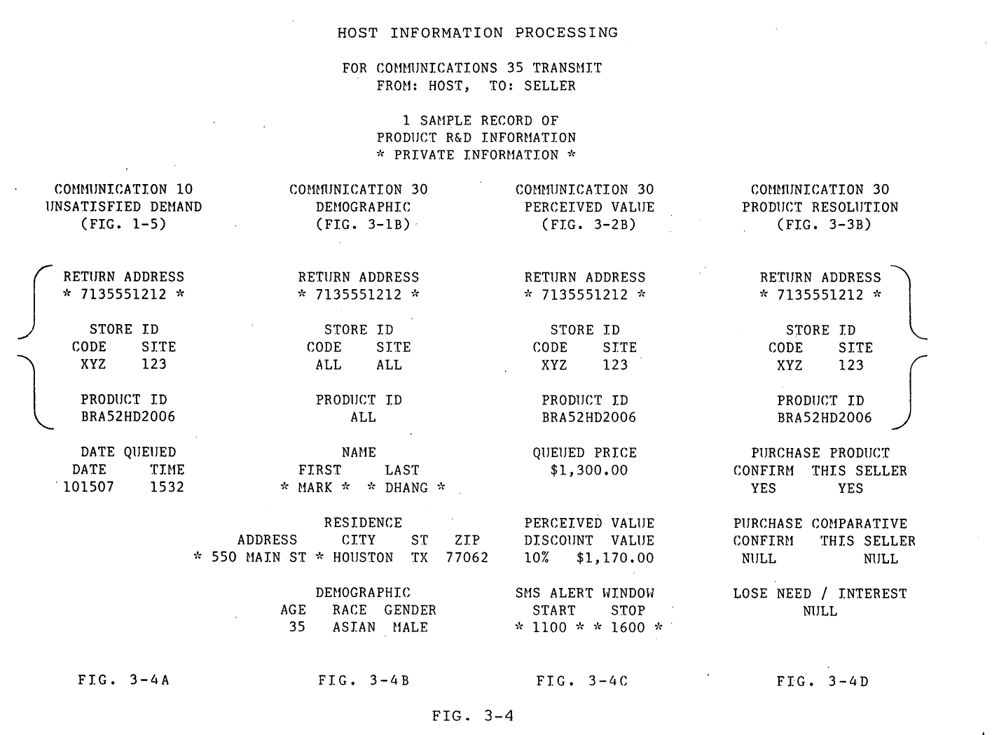

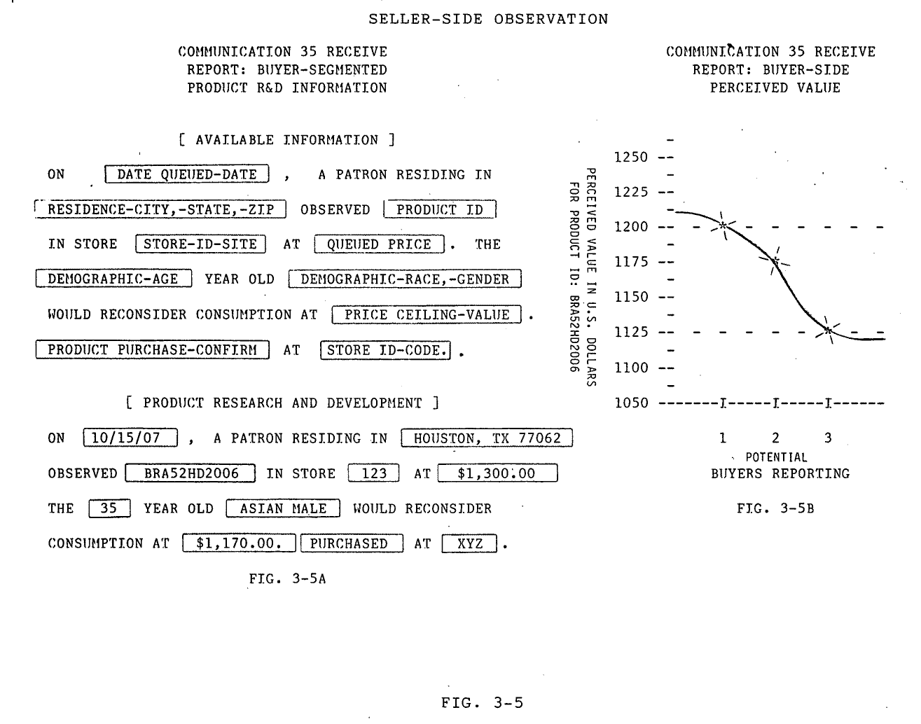

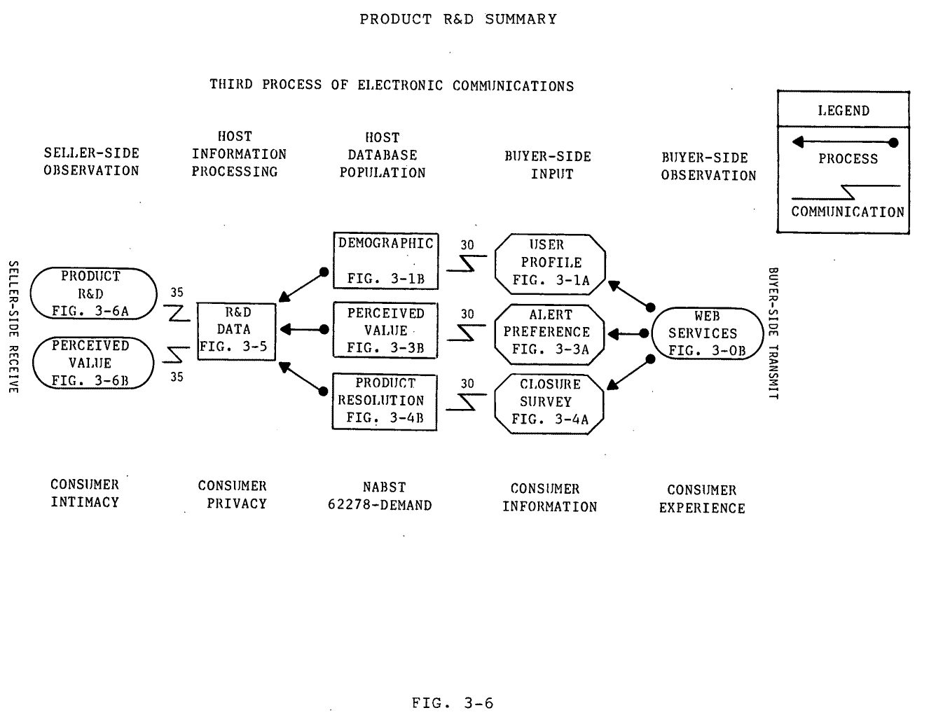

Resource: 12th Edition Economics—McGraw-Hill With reference to FIG. 4-1, prior art concerning “The Circular Flow of Output and Income”. This model implies a complex, interrelated web of decision making and economic activity. The preferences of buyers and sellers are registered on the demand side and the supply side of various product markets. Consumers, unrestrained by government and with incomes from the sale of resources spend their dollars on those goods they are most willing and able to buy. These expenditures are “dollar votes” by which consumers communicate their wants through the demand side of the product market. The problem which exists in this state of technology is the “wall of uncertainty”. This uncertainty results from a lack of buyer demand information communicated to the seller absent from purchase in the product market (unsatisfied demand). With reference to FIG. 4-3, it is an object of this invention to provide an alternative method of economic communication absent from purchase by means of a text message system.

### BRIEF SUMMARY OF THE INVENTION

Ultimately buyers and sellers share the common goal of consumption, the sole end of all economic activity. To improve the desired result, unsatisfied demand must receive an account of modified supply. Interrelationships will not occur by accident or by fiat. Positive organizational mechanisms must be put into place to pursue interrelationships and to ease inherent coordination and communication difficulties in making them work. At the same time technology is creating interrelationships, it is also reducing costs of exploiting them. The ease of communication has increased just as dramatically as its cost have fallen. By using novel ways of interacting, we will find a whole new set of financial structures to which we can choose to belong.

Properly targeted information regarding supply of goods is more cost effective than informing a mass audience. Information delivered directly to a consumer who may be interested in a particular product is one way to utilize text messaging technology for targeted communication purposes. No system is in place, however, for consumers to target a supplier by means of a text message with information concerning an opportunity for exchange that exist. A system which enabled the self-serving consumer to indicate their personal element of demand for a particular product so they would be alerted to modified supply or new promotion information for the desired product would be highly effective. The suppliers analysis of reliable buyer-segmented product demand concerning the consumer they target would minimize uncertainty, eliciting appropriate incentive schemes and attainment of a superior allocative solution. Targeted delivery of modified supply information to the consumer with protection from unsolicited seller spam in this transaction is very desirable.

It is my intent to better link market participants. The blueprint has a social base, a technological plan and some basic economic philosophy to coordinate the economic activities of large numbers of individuals and businesses with Ready to Implement Technology (RIT). The NABST Market Mechanism (Notification And Bookmark Sales Tool) is an elaborate communication system through which innumerable individual free choices of buyers and sellers are recorded, summarized and properly balanced against one another. Serving ultimately as a mechanism for enhancing economic communication and exchange. A new buying approach improves access to seller information while forward integration of research enhances buyer convenience. The cost of a product includes not only financial costs but also time and convenience costs. The costs of time reflects the opportunity costs of using it elsewhere. Buyer value results from lowering any of these costs. A new selling approach improves access to the buyer while every point of contact represents an opportunity to influence the perception of a firm and imparts value. It is an object of this invention to provide such a communication system.

One embodiment of the invention provides an electronically implemented targeted communications method carried out by a host computer. The host computer receives a plurality of first electronic communications from potential buyers containing return address information, store ID information and product ID information. A database is then formed comprising the return address information for a plurality of addresses, store ID information for a plurality of stores and product ID information for a plurality of products. The host computer transmits aggregate non-address information to the store associated with the same product. The host computer then receives a plurality of second electronic communications from at least one seller containing store ID information, product ID information and new promotion information. A database is then formed comprising the store ID information for a plurality of stores, product ID information for a plurality of products and new promotion information for a plurality of promotions. The host computer associates the first electronic communications and second electronic communications containing the same store ID information and product ID information, then transmits new promotion information to the potential buyers address associated with the store and product in the database. The host computer then receives a plurality of third electronic communications from potential buyers containing return address information, store ID information and product ID information along with demographic information or perceived value information or product resolution information. The host computer merges the third electronic communications into database records of first electronic communications containing the same return address information, store ID information and product ID information. The host computer transmits aggregate non-address information of merged database records to the store associated with the same product.

In this method, there is communication concerning an exchange opportunity between two parties. Supply does sellers no good unless it can be matched with some corresponding demand. Unsatisfied consumer demand information is observable and communicated to the proper supplier. New promotion information is properly targeted back to the potential buyer, who in effect is requesting to be notified of modified supply or new promotion information for the product under consideration.

In another embodiment of the invention, there is provided a communication system for a potential buyer of a product and a seller of the product. The system comprises a buyer-side user input/output device, a host computer system provided with machine readable instructions for operability and a seller-side user input/output device. The buyer-side user input/output device is for transmitting return address information for responsive communications, store ID information concerning the store of product observation and product ID information concerning a product in demand to the host computer system. The host computer system is for receiving return address information, store ID information and product ID information from the buyer-side user input/output device and electronically storing such information in a database record of unsatisfied demand. The host computer system is provided with computer instructions for generating reports of aggregate product demand information sorted by store ID and product ID and optionally other keys and/or providing the seller-side user input/output device remote retrieval of information other than the address from the database for their own analysis of aggregate product demand. The seller-side user input/output device is for receiving reports of aggregate product demand information and/or requesting and retrieving information other than the address from the host computer system and for transmitting store ID information concerning the store of product availability, product ID information concerning a product in supply and new promotion information extended to the potential buyer back to the host computer system. The host computer system is for further receiving the store ID information, product ID information and new promotion information from the seller-side user input/output device and electronically storing such information in a database record of modified supply. The host computer system is provided with computer instructions for associating the store ID and product ID of a database record of unsatisfied demand with the store ID and product ID of a database record of modified supply and forward new promotion information to the return address of the buyer-side user input/output device as a responsive communication. The buyer-side user input/output device is for receiving the new promotion information from the host computer system and further transmitting return address information for responsive communications, store ID information concerning the store of product observation and product ID information concerning the product in demand along with demographic information concerning the potential buyer demographic or perceived value information concerning the potential buyer assessment of the product in demand or product resolution information concerning the outcome of the buyer-side/seller-side communication for the product to the host computer system. The host computer system is further provided with computer instructions for receiving from the buyer-side user input/output device return address information, store ID information and product ID information along with demographic information or perceived value information or product resolution information and electronically merging such information in a database record of product R&D. The host computer system is further provided with computer instructions for generating database reports of aggregate product R&D information sorted by store ID and product ID and optionally other keys and/or providing the seller-side user input/output device remote retrieval of information other than the address from database records of product R&D for seller analysis of aggregate product R&D. The seller-side user input/output device is for further receiving database reports of aggregate product R&D information from the host computer system and/or requesting and retrieving information other than address from database records of product R&D for seller analysis of aggregate product R&D.

The system makes the true state of unsatisfied demand and modified supply more readily known to market participants. Communication is highly targeted, has at least implied consent to responsive communications and provides aggregate buyer-segmented demand information that can be used by seller-side users for a variety of analysis and planning purposes. A particular allocation of resources which is now most efficient for a given pattern of consumer tastes, range of technological alternatives and for given supplies of resources are subject to all change. As consumer preferences and technology change it is best to monitor the changing trends. By providing the seller access to reliable strategic information concerning the characteristics and/or thought process of the consumer whom they target, costs of decision making is reduced for a superior allocative solution. The system also communicates modified seller supply information to properly targeted buyer-side users and provides protection to consumers against unsolicited seller spam. It is an object of this invention to enhance economic communication of unsatisfied demand and modified supply by providing such a system.

### BRIEF DESCRIPTION OF THE SEVERAL VIEWS OF THE DRAWING

### Unsatisfied Demand Information

FIG. 1-0 depicts the proprietary code format and proprietary image which comprise the “NAB-IT ID”.

FIG. 1-1 depicts a buyer-side observation of a seller-side solicitation which includes instructions for submitting unsatisfied demand information to the host (NABST) for monitoring.

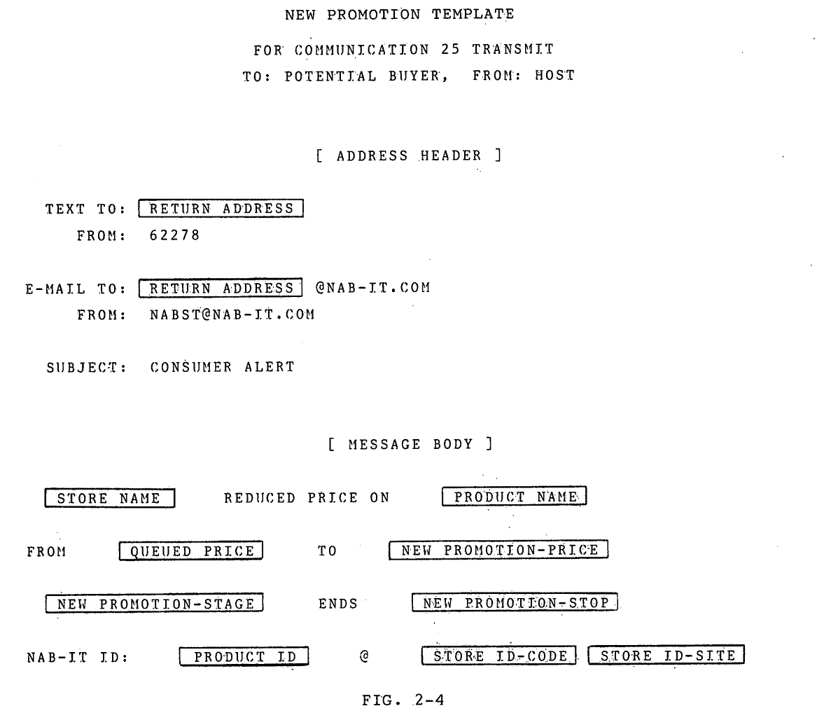

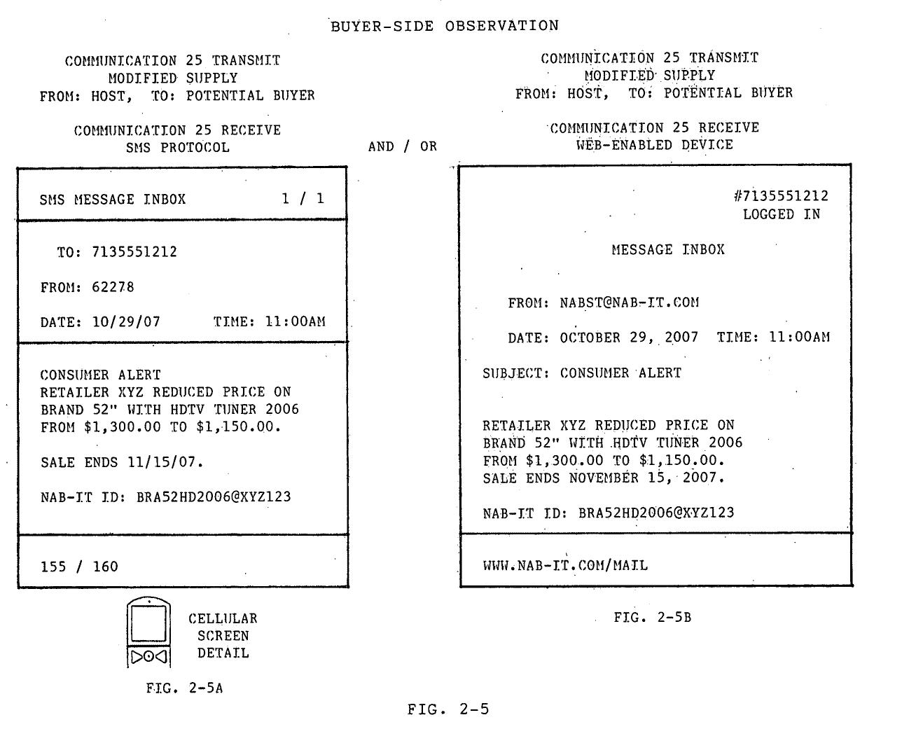

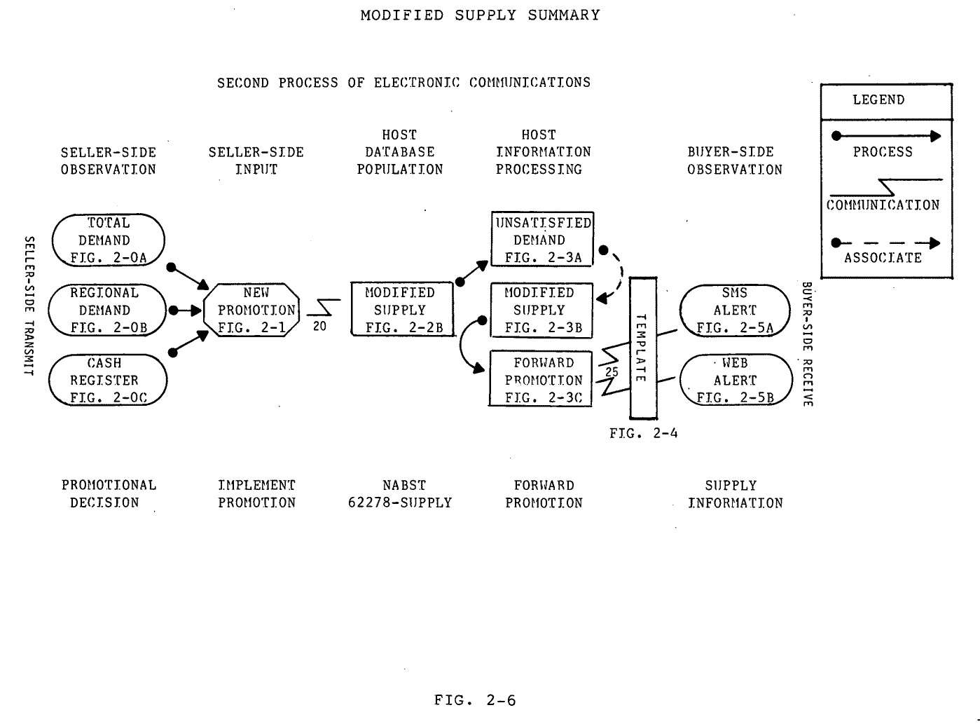

FIG. 1-2 depicts buyer-side input of unsatisfied demand using a cellular device enabled with (A) MMS protocol or (B) SMS protocol.

FIG. 1-3 depicts host (A) decoding and (B) translation of “NAB-IT ID” prompting (C) buyer-side confirmation of unsatisfied demand for data integrity.

FIG. 1-4 depicts a host request for buyer-side input confirming unsatisfied demand using (A) SMS protocol or (B) web-enabled device.

FIG. 1-5 depicts host database population of confirmed unsatisfied demand comprising at least return address information, store ID information and product ID information.

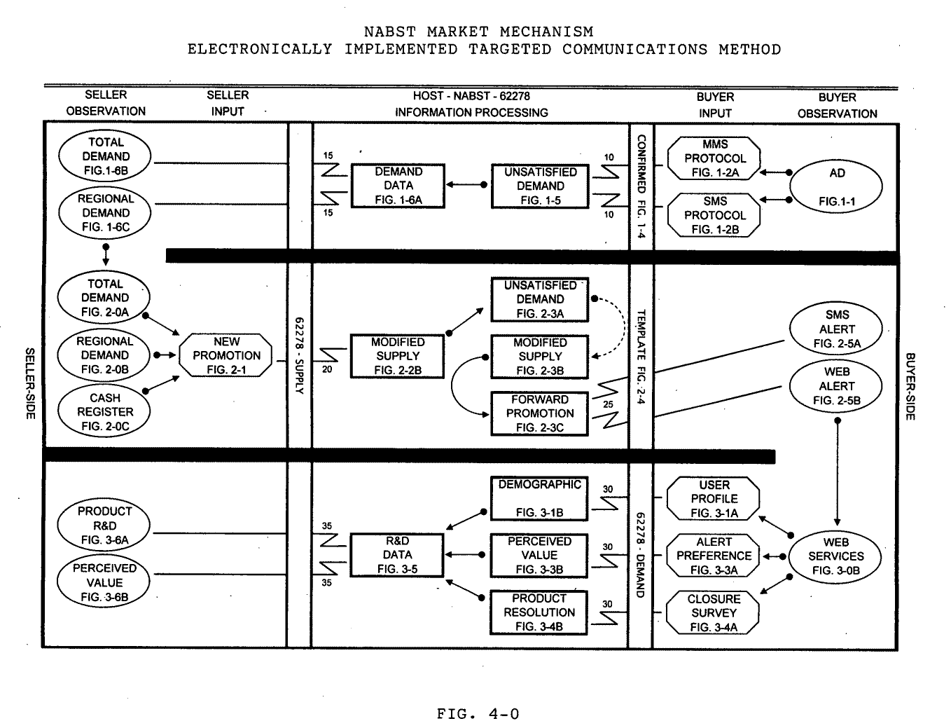

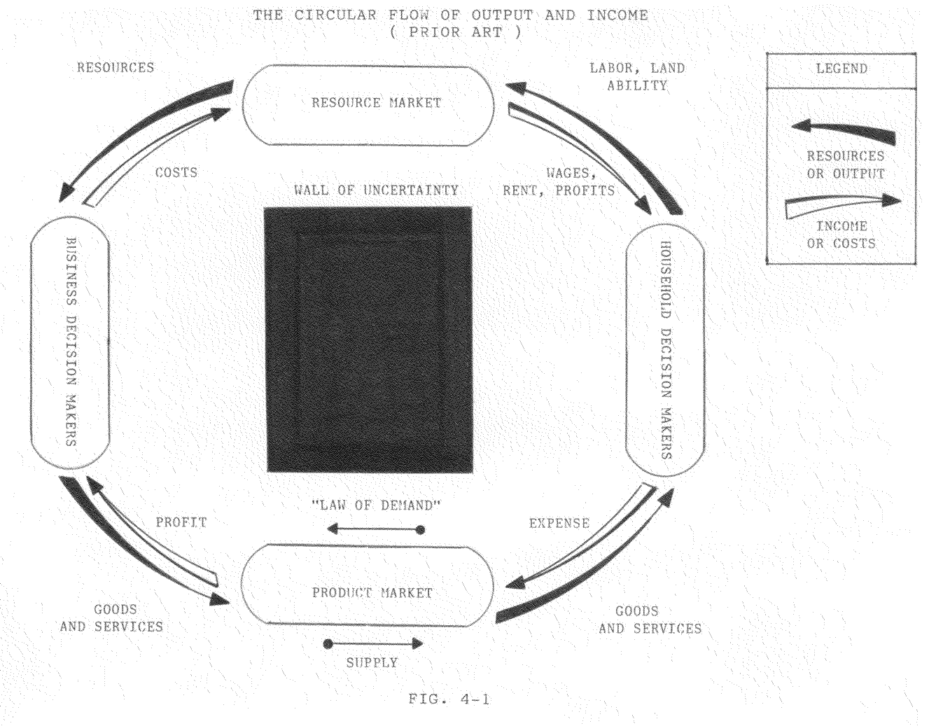

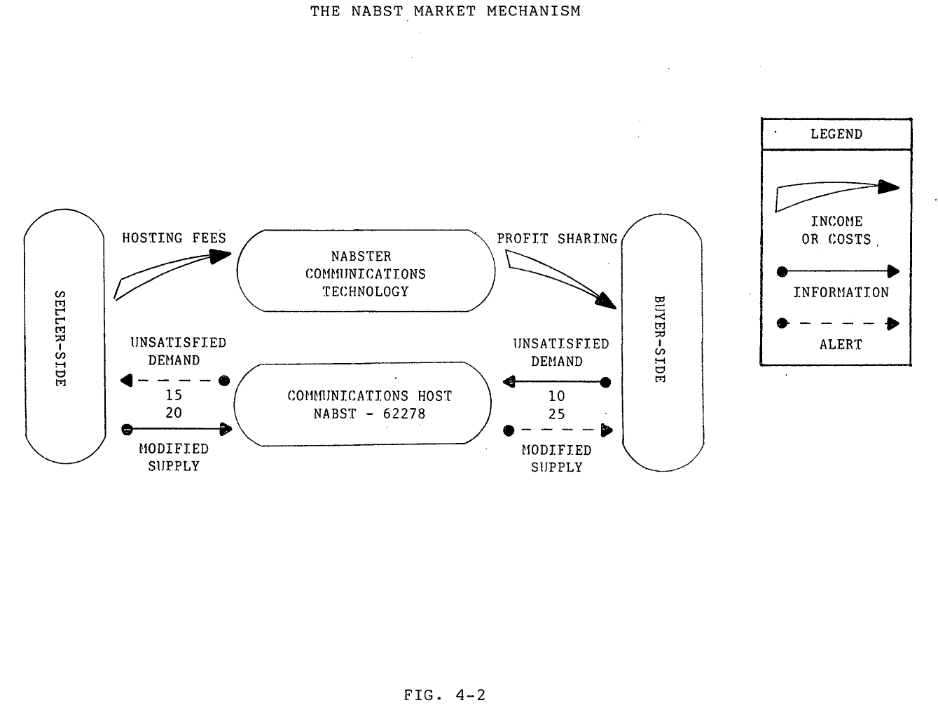

FIG. 1-6 depicts (A) host information processing for seller-side import and a seller-side observation of (B) total unsatisfied demand or (C) regional unsatisfied demand for a particular product.

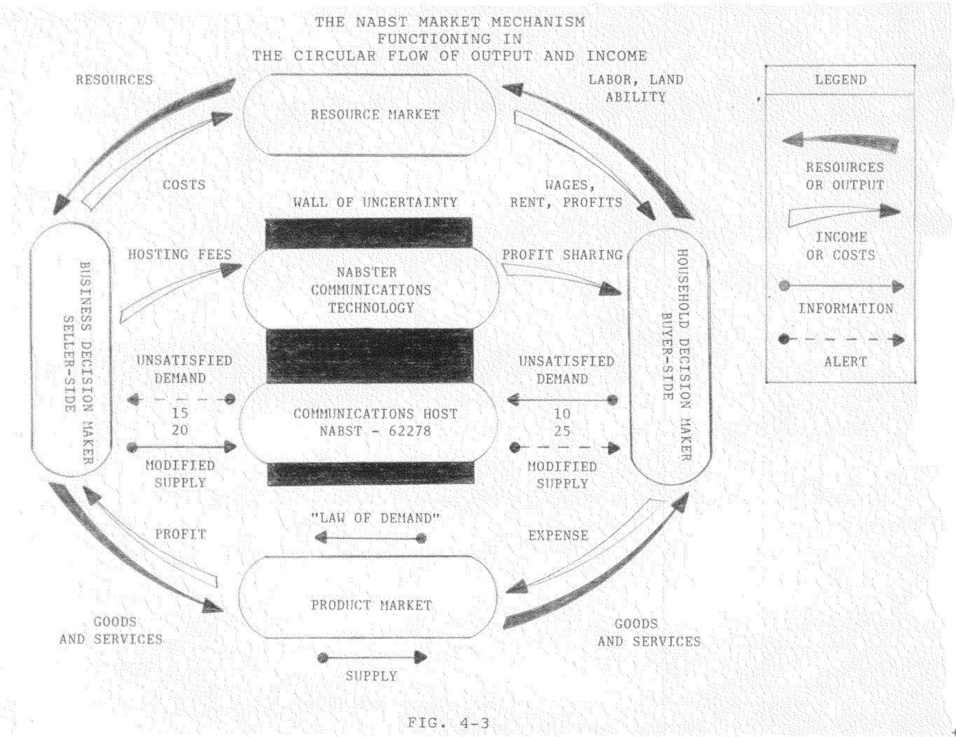

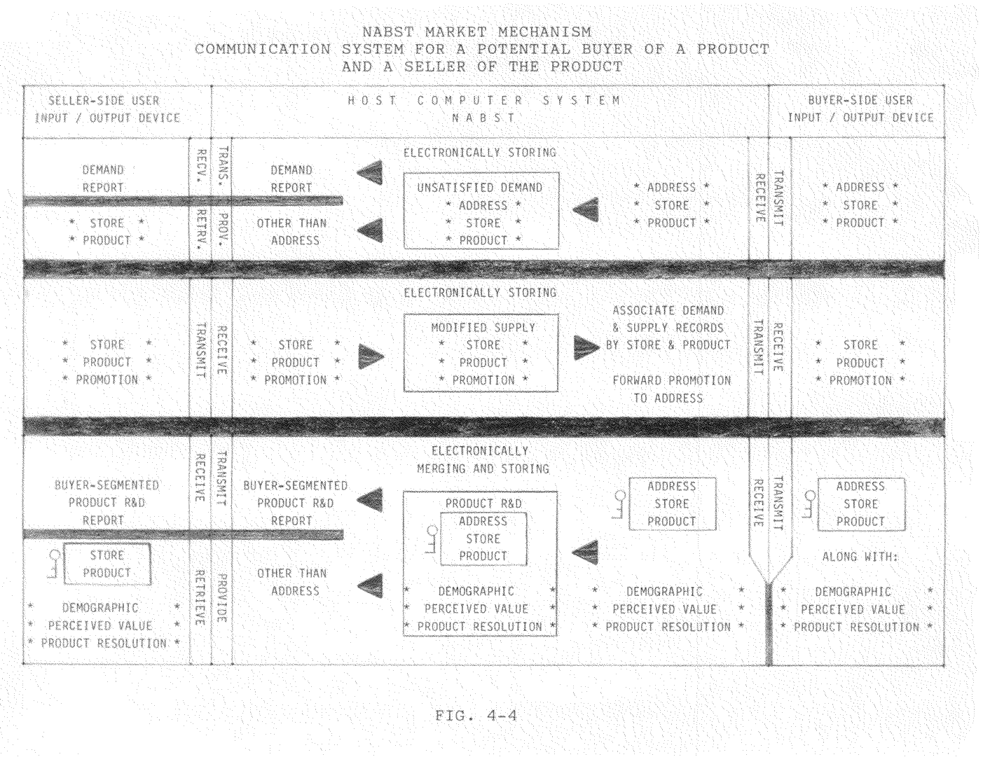

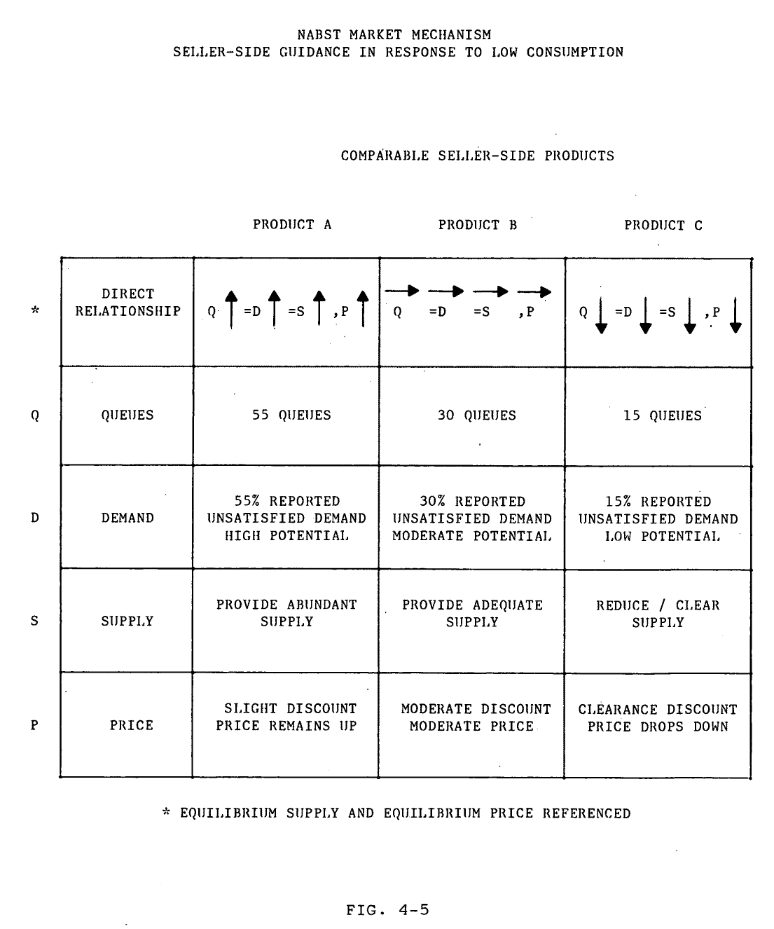

FIG. 1-7 depicts process of unsatisfied demand information from a potential buyer to a seller in accordance with an embodiment of the invention. (Unsatisfied Demand Summary)

### Modified Supply Information

FIG. 2-0 depicts a seller-side observation of (A) total unsatisfied demand, (B) regional unsatisfied demand for a particular product and (C) satisfied demand.

FIG. 2-1 depicts a seller-side data management system with a scheduled implementation of a new promotion.

FIG. 2-2 depicts (A) seller-side input of new promotion information and (B) host database population of modified supply comprising at least store ID information, product ID information and new promotion information.

FIG. 2-3 depicts (A) record of unsatisfied demand associated to (B) record of modified supply in the host (NABST) database and (C) new promotion information forwarded to the potential buyer as a responsive communication.

FIG. 2-4 depicts population of new promotion information into a consumer alert template.

FIG. 2-5 depicts a buyer-side observation of modified supply information in a consumer alert received on (A) cellular device in SMS protocol and/or (B) web-enabled device as E-Mail.

FIG. 2-6 depicts process of modified supply information from a seller to a potential buyer in accordance with an embodiment of the invention. (Modified Supply Summary)

### Product R&D Information

FIG. 3-0 depicts a buyer-side observation of (A) temporary password for web services and (B) login using cellular number and password on a web-enabled device.

FIG. 3-1 depicts buyer-side input of (A) user profile information required before using the notification service and (B) database record of buyer perceived value as populated by the user profile.

FIG. 3-2 depicts buyer-side input of (A) SMS alert preference information indicating criteria for SMS alert and (B) database record of buyer perceived value as populated by the SMS alert preference.

FIG. 3-3 depicts buyer-side input of (A) closure survey information required to discontinue product notification and (B) database record of buyer product resolution as populated by the closure survey.

FIG. 3-4 depicts host information processing into a record of product R&D by merging (A) unsatisfied demand with (B) demographic information, (C) perceived value information and (D) product resolution information.

FIG. 3-5 depicts seller-side observation of (A) buyer-segmented product R&D information and (B) buyer perceived value for a particular product for seller analysis.

FIG. 3-6 depicts process of product R&D information from a potential buyer to a seller in accordance with an embodiment of the invention. (Product R&D Summary)

### NABST Market Mechanism

FIG. 4-0 depicts an electronically implemented targeted communications method in accordance with an embodiment of the invention.

FIG. 4-1 depicts prior art information concerning resource flow between business and consumers with communication of demand through purchase in the product market.

FIG. 4-2 depicts flow of unsatisfied demand information and modified supply information in accordance with an embodiment of the invention.

FIG. 4-3 depicts how implementation of the invention enhances economic communication and exchange in the buyer/seller relationship. (FRONT PAGE VIEW)

FIG. 4-4 depicts a communication system for a potential buyer of a product and a seller of the product in accordance with an embodiment of the invention.

FIG. 4-5 depicts equilibrium market guidance based upon unsatisfied consumer demand.

### DETAILED DESCRIPTION OF THE INVENTION

With reference to FIG. 4-0, one embodiment of the invention provides an electronically implemented targeted communications method carried out by a host computer 62278. The host computer 62278 can be viewed as having a function side 62278-demand for processing communications from a potential buyer of a product and a function side 62278-supply for processing communications from the seller of the product. With reference to FIG. 1-2, the host computer 62278-demand receives a plurality of first electronic communications 10 from buyer-side users. Each of the plurality of first electronic communications containing at least return address information for a potential buyer, store ID information and product ID information. With reference to FIG. 1-5, database records are formed in the host computer comprising the return address information for a plurality of addresses, store ID information for a plurality of stores and product ID information for a plurality of products. With reference to FIG. 1-6, the host computer transmits aggregate non-address information in communication 15 to the store recorded with the product in the database. With reference to FIG. 1-7, the process of unsatisfied demand information can be summarized from a buyer to the seller in accordance with an embodiment of the invention. With reference to FIG. 2-2, the host computer 62278-supply then receives a plurality of second electronic communications containing at least store ID information for the seller, product ID information and new promotion information. A database is then formed in the host computer comprising the store ID information for a plurality of stores, product ID information for a plurality of products and new promotion information for a plurality of promotions. With reference to FIG. 2-3, the host computer associates (A) database records of first electronic communications 10 and (B) database records of second electronic communications 20 containing the same store ID information and product ID information and (C) forwards new promotion information in communication 25 to the return address of buyer-side users recorded with the same store and product in the database. With reference to FIG. 2-6, the process of modified supply information can be summarized from a seller to the buyer in accordance with an embodiment of the invention. With reference to FIG. 3-1, FIG. 3-2 and FIG. 3-3, the host computer 62278-demand receives a plurality of third electronic communications containing at least return address information for a potential buyer, store ID information and product ID information along with demographic information or perceived value information or product resolution information. With reference to FIG. 3-4, the host computer merges third electronic communications 30 into database records of first electronic communications 10 containing the same return address information, store ID information and product ID information. With reference to FIG. 3-5, the host computer transmits aggregate non-address information in communication 35 to the store recorded with the same product in the database. With reference to FIG. 3-6, the process of product R&D information can be summarized from a buyer to the seller in accordance with an embodiment of the invention.

In this method, there is communication concerning an exchange opportunity between two parties. Supply does sellers no good unless it can be matched with some corresponding demand. Unsatisfied consumer demand information is observable and communicated to the proper supplier. New promotion information is properly targeted back to the potential buyer, who in effect is requesting to be notified of modified supply or new promotion information for the product under consideration.

With reference to FIG. 1-2, because text messaging is becoming increasingly popular, it is contemplated that the plurality of first electronic communications 10 concerning unsatisfied product demand is transmitted in (A) MMS protocol or (B) SMS protocol. With reference to FIG. 2-5A, new promotion information concerning modified product supply in communication 25 is transmitted to the return address recorded with the same store and product in the database in SMS protocol. As technology progresses and becomes widely available, it is contemplated communications 10 and communications 25 will be transmitted with a proprietary image in MMS, EMS and other messaging protocols.

With reference to FIG. 1-5, the plurality of first electronic communications 10 from a potential buyer preferably contains at least return address information representative of where the potential buyer would like to receive responsive communications concerning the product, store site information (store ID-site) concerning the specific location the product was observed, product ID information (generally will comprise a product code selected from the group SKU, UPC, EAN, GTIN, VIN, MLS# and inventory numbers) and date queued information concerning the date and time the first electronic communication 10 was transmitted to the host computer 62278-demand. The host computer forms a database comprised of this information and with reference to FIG. 1-6, generates database reports of aggregate non-address information and transmits the reports to the associated seller in communication 15 and/or permits the seller to access the database for non-address information for analysis of aggregate product demand.

With reference to FIG. 2-2, the plurality of second electronic communications 20 from the seller preferably contains at least store site information (store ID-site) concerning the specific location the product is available, product ID information (generally will comprise a product code selected from the group SKU, UPC, EAN, GTIN, VIN, MLS# and inventory numbers), new promotion information concerning the product, price schedule information including all past and present stages of product pricing, store name information corresponding to the store ID information and product name information corresponding to the product ID information. The host computer forms a database comprised of this information and with reference to FIG. 2-3, relates date queued information to price schedule information, store ID information to store name information and product ID information to product name information. With reference to FIG. 2-4, the host computer populates the consumer alert template with new promotion information, related price information, store name information and product name information. With reference to FIG. 2-5, the host computer transmits the consumer alert in communication 25 to the return address recorded with the same store and product in the database.

With reference to FIG. 3-4, the plurality of third electronic communications 30 from a potential buyer preferably contains at least return address information, store ID information and product ID information along with residence information concerning the place the potential buyer resides, demographic information concerning the age, race and gender of the potential buyer, perceived value information concerning the potential buyer's assessment of the product in demand and product resolution information concerning the outcome of the buyer-side/seller-side communication for the product. The host computer merges the plurality of third electronic communications into database records of first electronic communications containing the same return address information, store ID information and product ID information and with reference to FIG. 3-5, generates database reports of aggregate non-address information and transmits the reports to the associated seller in communication 35 and/or permits the seller to access the database for non-address information for analysis of aggregate product R&D.

With reference to prior art in FIG. 4-1, concerning The Circular Flow of Output and Income. This model implies a complex interrelated web of decision making and economic activity. The preferences of buyers and sellers are registered on the demand and supply side of various product markets. Consumers, unrestrained by government and with incomes from the sale of resources spend their dollars on those goods they are most willing and able to buy. These expenditures are “dollar votes” by which consumers communicate their wants through the demand side of the product market. The dollar votes of consumers play a key role in determining what products a profit seeking business will supply and at what cost. The problem which exist in this state of technology is the “wall of uncertainty”. This uncertainty results from a lack of buyer demand information communicated to the seller absent from purchase in the product market (unsatisfied demand). With reference to FIG. 4-2, it should be noted, however, the method would be operable from the consumers point of view without knowledge of aggregate demand information being communicated to the sellers. Additionally, the seller could communicate information of modified product supply to prospective buyers only indirectly by means of the host computer. This method is preferred, however, since it will protect the buyer-side users from unsolicited seller-side spam. With reference to FIG. 4-3, we examine a hypothetical model making explicit use of the demand and supply components of microeconomics. A hypothetical illustration which explicitly embodies the formal components of economical analysis. The model explored emphasizes the interrelatedness of the many decision makers who comprise the purely competitive economy. It is an object of this invention to provide an alternative method of economic communication absent from purchase by means of a text message.

In another embodiment of the invention, the method can be implemented by means of a communication system for a potential buyer of a product and a seller of the product. With reference to FIG. 4-4, the system comprises a buyer-side user input/output device, a host computer system provided with machine readable instructions for operability and a seller-side user input/output device. A buyer-side user input/output device is for transmitting at least return address information for responsive communications, store ID information concerning the store of product observation and product ID information concerning the particular product in demand to a host computer system. A host computer system is for receiving at least the return address information, store ID information and product ID information from a buyer-side user input/output device and electronically storing such information in a database record of unsatisfied demand. The host computer system is provided with operably associated computer instructions for generating database reports of aggregate product demand information sorted by store ID and product ID and optionally other key or key combination and transmitting the reports to a seller-side user input/output device and/or providing a seller-side user input/output device remote retrieval of information other than the address from database records of unsatisfied demand for seller analysis of aggregate product demand. A seller-side user input/output device is for receiving database reports of aggregate product demand information from a host computer system and/or requesting and retrieving information other than the address from a host computer system database for seller analysis of aggregate product demand and for transmitting at least store ID information concerning the store of product availability, product ID information concerning a product in supply and new promotion information concerning a new promotion extended to the potential buyer back to a host computer system. A host computer system is for further receiving at least the store ID information, product ID information and new promotion information from a seller-side user input/output device and further electronically storing such information in a database record of modified supply. The host computer system is further provided with operably associated computer instructions for associating store ID and product ID of a database record of unsatisfied demand with store ID and product ID of a database record of modified supply and forward at least new promotion information to the associated return address of a buyer-side user input/output device as a responsive communication. A buyer-side user input/output device is for receiving at least new promotion information from the host computer system and further transmitting at least return address information for responsive communications, store ID information concerning the store of product observation and product ID information concerning the product in demand along with demographic information concerning the potential buyer demographic or perceived value information concerning the potential buyer's assessment of the product in demand or product resolution information concerning the outcome of the buyer-side/seller-side communication for the product to a host computer system. The host computer system is further provided with operably associated computer instructions for receiving from the buyer-side user input/output device, return address information, store ID information and product ID information along with demographic information or perceived value information or product resolution information and electronically merging such information in a database record of product R&D. The host computer system is further provided with operably associated computer instructions for generating database reports of aggregate product R&D information sorted by store ID and product ID or other key or key combination and transmitting the reports to a seller-side user input/output device and/or providing a seller-side user input/output device remote retrieval of information other than the address from database records of product R&D for seller analysis of aggregate product R&D. The seller-side user input/output device is for further receiving database reports of aggregate product R&D information from the host computer system and/or requesting and retrieving information other than the address from database records of product R&D for seller analysis of aggregate product R&D. The communications preferably contain additional data items as indicated elsewhere herein.

The system makes the true state of unsatisfied demand and modified supply more readily known to market participants. Communication is highly targeted, has at least implied consent to responsive communications and provides aggregate buyer-segmented demand information that can be used by seller-side users for a variety of analysis and planning purposes. A particular allocation of resources which is now most efficient is subject to change. As consumer preferences and technology change it is best to monitor the changing trends. By providing the seller access to reliable strategic information concerning the characteristics and/or thought process of the consumer whom they target, costs of decision making is reduced for a superior allocative solution. The system also communicates modified seller supply information to properly targeted buyer-side users and provides protection to consumers against unsolicited seller-side spam. It is an object of this invention to enhance economic communication of unsatisfied demand and modified supply by providing such a system.

With reference to FIG. 4-3, the use of a communication system for unsatisfied demand and modified supply information requiring examination and systematic arrangement by a proprietary NABST (Notification And Bookmark Sales Tool) will streamline the process of economic exchange. Generally any given product will be distributed to consumers on the basis of their ability and willingness to pay the existing market price for it. Those buyers who are able and willing to pay that price will get a unit of the product; those who are not, will not. When reluctant consumers normally disengage with passing desire, the NABST Market Mechanism engages them to remain active with their unsatisfied demand. Where economic communication heretofore has typically been implied, economic communication hereafter involves meaningful messages between economic participants. For example, with reference to FIG. 1-1, a buyer-side user upon seeing an item of interest would follow posted instructions to provide in the outgoing message a proprietary code containing store and product information concerning an opportunity for exchange that exist. The potential buyer is requesting and consenting to future communications relating to that store and product. The NABST identifies the message or data export received from either participant to be a notification of unsatisfied demand or modified supply and is recorded for reference, creating the functional sales tool. With reference to FIG. 2-0, a buyer-side user of the NABST would effectively communicate their personal element of unsatisfied demand for a particular product to targeted seller-side users of the system, generally selected from dealers, retail stores and agents representing property. With reference to FIG. 2-5, a seller-side user of the NABST would effectively communicate modified supply or new promotional messages for a desired product to targeted buyer-side users of the system. The NABST provides consumer protection from unsolicited seller spam in this transaction.

For obtaining the best results, the improved communication system comprises a multiplicity of buyer-side user input/output devices and a multiplicity of seller-side user input/output devices. For example, at least 1,000 buyer-side user input/output devices and at least 4 seller-side user input/output devices. A system this small would be beneficial in the automobile industry, for example.

With reference to FIG. 1-2, for efficiency, it is contemplated the system utilizes handheld devices, PDAs and cellular phones with imaging and/or messaging capabilities as the buyer-side user input/output device and the return address will comprise the phone number. The buyer-side user preferably transmits their phone number and a proprietary code known as the “NAB-IT ID” to a host computer system by means of a message service protocol. With reference to FIG. 1-0, for efficiency and elimination of keystroke errors, it is contemplated that the NAB-IT ID may comprise a proprietary image incorporating OCR (Optical Character Recognition) labeling of proprietary fields. By utilizing the imaging device and cropping the image to effectively capture the information, the buyer-side user is eliminating the manual reproduction of the text based NAB-IT ID. No additional software is required on the buyer-side user input/output device for interpretation or translation of the information. The image is delivered to the NABST by means of MMS protocol or data export. The computer instructions associated with the host computer system are further capable of deriving store ID-code information, store ID-site information and product ID information using OCR capabilities. Geometric symbols frame the extremities of the image to help identify and correct distorted captures. Unusable images are promptly identified by the NABST and a message is delivered to the buyer-side user input/output device requesting another submission of the NAB-IT ID to the system. With reference to FIG. 2-5, in time, the host computer preferably transmits new promotion information to the buyer-side user input/output device by means of a text message.

As technology progresses and becomes more widely available, for efficiency, it is contemplated the system will utilize handheld devices, PDAs and cellular phones with additional RFID (Radio Frequency ID) capabilities on the buyer-side user input/output device. Additional software is required on the device to derive store ID-code information, store ID-site information and product ID information required to compose the text based NAB-IT ID. The information is delivered to the NABST by means of SMS protocol or data export.

With reference to FIG. 2-1, the seller-side user must identify the products to be monitored by the NABST and export initial supply information to the host computer system comprising at least store name information corresponding to the store ID, product name information corresponding to the product ID and price schedule information. Because the absence of reliable information in the system tends to prevent the attainment of a superior allocative solution, the NABST verifies unsatisfied buyer-side demand for data integrity. With reference to FIG. 1-3, the host computer system (A) decodes the NAB-IT ID information and (B) translates this information to a corresponding store name and product name for (C) buyer-side confirmation of unsatisfied demand. With reference to FIG. 3-0, upon a buyer-side users initial participation from a particular number, a security layer is observed for registration of web services. A temporary password is transmitted to the return address of the buyer-side user input/output device in SMS protocol. With reference to FIG. 1-4, once registered with web services the store/product relationship is verified using buyer-side input in (A) SMS protocol or (B) on a web-enabled device. Confirmed unsatisfied demand information is then electronically recorded as an element of the buyer-side user personal product index. The product is then monitored by the individual and/or host, along with the rest of the products in their index, for modified supply coming into the NABST from seller-side users. For example; reduced MSRP, sale price, rebates, discontinuation, financing and other incentives. The host computer system utilizes this information to transmit new promotions by text message or electronic mail (E-Mail) to the buyer-side user input/output device as a responsive communication, encouraging them to reevaluate their potential consumption of the desired product.

With reference to FIG. 1-5, the communication system preferably comprises means for transmitting additional demand information from the buyer-side user input/output device, for example, date queued information concerning the date and time the product was queued for monitoring. With reference to FIG. 2-2, the communication transmitted from the seller-side user input/output device preferably also contains additional supply information, for example, price schedule information including date and time information for all past and present stages of product pricing, store name information concerning the store outlet name and product name information concerning the product label. The computer instructions operably associated with the host computer system are capable of relating date queued information to price schedule information to establish a queued price reference relative to the new promotion. Additionally, product demand is more elastic the longer the time period under consideration. Date and time information in the database could be used by sellers to weed out stale leads.

It is well known to those familiar with economics, that geographic location may be important directly as a cost driver. The location of the buyer's primary dwelling emerges as the most important geographic segmentation variable even though the buyer may use the product somewhere else. With reference to FIG. 3-1, the communication system preferably comprises means for transmitting the buyer-side user zip code to the NABST during a user profile procedure. Where reports are to be generated, the computer instructions associated with the host computer system are preferably capable of sorting unsatisfied demand information based on buyer-side user zip code and transmit the report to the seller-side user having the location, or marketing power in the location. Buyer demographic can be a proxy for the desired product attributes, price sensitivity and other signaling criteria. Additionally, the communication system preferably comprises means for transmitting the buyer-side user demographic information to the NABST during the user profile procedure. For example, some key factors may include: age group, race, gender, household size, decision maker and occupation of the potential buyer. Where reports are to be generated, the computer instructions associated with the host computer system are preferably further capable of reporting demographic breakdown of unsatisfied product demand. Potential buyers of a product not currently purchasing may also constitute a buyer segment.

It is well known to those familiar with economics, that a firm or household does not purchase a product; individual decision makers do. Both actual value and signals of value are assessed and interpreted by these decision makers. Purchase criteria is in meeting perceived value for the buyer. With reference to FIG. 3-2, the communication system preferably comprises means for transmitting buyer-side perceived value information from the buyer-side user input/output device. Or alternatively, perceived value information could be transmitted to the NABST during an SMS alert preference procedure. Where reports are to be generated, the computer instructions associated with the host computer system are preferably capable of charting aggregate perceived value information and transmitting the report to the seller-side user whose potential buyers are reflected in the report. The competitive firm does not have a price policy; that is, the ability to freely adjust price. Rather, the firm can merely adjust to the socially optimal price. The competitive seller is a price taker rather than a price maker.

Evidence concerning the economic effects of modified prices is mixed because studies are plagued by data problems and difficulties in determining cause and effect. With reference to FIG. 3-3, the communication system preferably comprises means for transmitting if a particular product was purchased and from which seller. The buyer-side user product resolution information could be transmitted to the NABST during a seller/product closure survey procedure. With reference to FIG. 3-4, the computer instructions associated with the host computer system are preferably capable of merging the communications for a particular buyer/seller product relationship into records of buyer-segmented product R&D for seller-side analysis. With reference to FIG. 3-5, simultaneous benefits include lower cost of marketing research and lower marketing overhead for acquiring equivalent information.

If society registers votes for consumer goods, individual producers and resource suppliers can only adjust to the wishes of buyers as tabulated and communicated by the market system. In communicating between entities with messaging enabled devices, the computer networks have as their job to enable the information space and perform administration. It makes more sense to also bring computers more into the action, to put their analytical power to work in translation, making sense of the vast content. The NABST connects massive data sets allowing statistical algorithms to find economic patterns with unprecedented fidelity. Incoming communications from buyer-side users are preferably analyzed using seller provided criteria, either by seller-side users after retrieval of the necessary unsatisfied demand data from the NABST or in the host computer system with reports generated and transmitted to the seller-side user input/output device associated with such demand. For example, the analysis can summarize unsatisfied product demand with preferential emphasis in various areas such as: (1) identification of product demand by geographic region or store site, (2) identification of product demand by buyer demographic, (3) resolution of buyer/seller communication regarding a product in demand, (4) identification of a potential buyer's perceived value for a product in demand, (5) With reference to FIG. 4-5, the direct relationship of product demand to guide equilibrium supply and equilibrium pricing, (6) identification of potential supply chain management issues concerning future consumption of a particular product. Analysis of unsatisfied demand and modified supply information can be used to trace interactions between various product markets. With reference to FIG. 2-1, where opportunity to stimulate consumption is identified, new promotion information is exported from the seller-side user input/output device to the host computer to implement the new promotion. It is contemplated that in time, with significant accumulation of statistical data concerning buyer-segmented cause and effect in a particular product market. The host will provide services which factor in numbered units of available seller supply in addition to all R&D variables present in the current environment of demand to guide in the rationing function of equilibrium product supply and pricing.

It is well known to those familiar with commerce that satisfying buyer needs is at the core of success in any business endeavor. A firm can differentiate itself by satisfying buyer needs better than its competitors. Information may be a mechanism through which a firm can increase its share of the market and strengthen consumer loyalty to its particular product. The improved communication system can be implemented for various business industries. In addition to retail, some sectors that are to be targeted include motor vehicle sales and real estate. The process would be used in the same way with the exception of the actual format of the product ID information comprising the NAB-IT ID. Along with using SKU, UPC, EAN and GTIN codes, the product ID for the new sectors could be comprised of, but not limited to, VIN, MLS# and inventory numbers.

A decision maker will generally adopt a new way of doing something when the cost-benefit ratio is favorable over alternative methods for completing the equivalent task. Economic efficiency results when maximum benefits are received at minimum cost from resources available. Simultaneous benefits can be realized while reducing cost for both sellers and buyers. In reducing seller cost, the system utilizes the most efficient communication technology available to effectively fill a perceived seller need better, longer and at a lower cost. Targeted seller needs include but are not limited to: (1) reliable information concerning the state of unsatisfied demand for the consumer they target, (2) ability to engage consumer desire at the point of observation, (3) a new sales tool improving access to targeted buyers for responsive stimulation, (4) reliable information for a greater allocative solution, (5) strategic information concerning buyer-segmented product R&D, (6) improved consumer confidence and loyalty. The competitive market contains the incentive for technological advance. Benefits of new cost-cutting techniques give the innovating firm at least a temporary advantage over its rivals. Lower costs mean economic profits for the pioneering firm. By passing part of this cost reduction to the consumer through lower product price, the firm can increase sales and obtain economic profits at the expense of rival firms. The inexpensive means of acquiring and providing useful information to consumers lowers search costs. The lower product price which the technological advance permits will cause the innovating firm to expand. In reducing buyer cost, the system utilizes the most efficient communication technology available to effectively fill a perceived buyer need better, longer and at a lower cost. Targeted buyer needs include but are not limited to: (1) a new buying approach improving access to reliable seller information concerning a product, (2) ability to monitor exclusive products free from unsolicited seller spam, (3) a new consumer tool reducing time and exertion using forward integration to take over routine buyer function, (4) new promotions encouraging product consumption, (5) perceive seller interest in consumer well-being. Benefits of the new cost-cutting techniques enhance buyer convenience. Timely information regarding prices assist rational and efficient decisions regarding consumption. Ultimately consumers realize the “income effect”, the impact of a change in price on a consumers real income and purchasing power.

While certain preferred embodiments of the invention have been described herein, the invention is not to be construed as being so limited, except to the extent that such limitations are found in the claims.

What is claimed is:

01. An electronically implemented targeted communications method carried out by a host computer comprising;
receiving, in a host computer, a plurality of first electronic communications, each of said plurality of first electronic communications containing return address information, store ID information and product ID information;
forming, in the host computer, database records comprising return address information for a plurality of addresses, store ID information for a plurality of stores and product ID information for a plurality of products;
transmitting, from the host computer, aggregate non-address information to the store ID recorded with the same product ID in the database;
receiving, in a host computer, a plurality of second electronic communications, each of said plurality of second electronic communications containing store ID information, product ID information and new promotion information;
forming, in the host computer, database records comprising store ID information for a plurality of stores, product ID information for a plurality of products and new promotion information for a plurality of promotions;
associating, in the host computer, database records of first electronic communications and database records of second electronic communications containing the same store ID information and product ID information, and;
transmitting, from the host computer, new promotion information to the return address recorded with the same store ID information and product ID information in the database.

02. A method as in claim 01 wherein said plurality of first electronic communications are received in MMS protocol or SMS protocol, and;
wherein new promotion information is transmitted to the return address recorded with the same store ID information and product ID information in the database in MMS protocol or SMS protocol.

03. A method as in claim 02 wherein the product ID information received in the first electronic communications and second electronic communications comprises a product code.

04. A method as in claim 03 wherein said plurality of first electronic communications received further contain store ID-site information and date queued information, and;
wherein said plurality of second electronic communications further contain store ID-site information, price schedule information, store name information and product name information.

05. A method as in claim 04 further comprising;
relating, in the host computer, date queued information to price schedule information; store ID information to store name information; and product ID information to product name information, and;
transmitting, from the host computer, new promotion information with related price schedule information, store name information and product name information to the return address recorded with the same store ID information and product ID information in the database.

06. A method as in claim 01 further comprising;
receiving, in a host computer, a plurality of third electronic communications, each of said plurality of third electronic communications containing return address information, store ID information and product ID information; along with demographic information or perceived value information or product resolution information;
merging, in the host computer, said plurality of third electronic communications into database records of first electronic communications containing the same return address information, store ID information and product ID information;
transmitting, from the host computer, aggregate non-address information of merged database records to the store ID recorded with the same product ID in the database.

07. A method as in claim 01 wherein the product ID information received in the first electronic communications and second electronic communications comprises a product code selected from the group SKU, UPC, EAN and GTIN.

08. A method as in claim 01 wherein the product ID information received in the first electronic communications and second electronic communications comprises a product code selected from the group consisting of VIN, MLS# and inventory numbers.

09. A communication system for a potential buyer of a product and a seller of the product comprising;
a) a buyer-side user input/output device for;
transmitting, to a host computer system, return address information for responsive communications, store ID information concerning the store of product observation and product ID information concerning a product in demand;
receiving, from the host computer system, new promotion information concerning the product in demand as a responsive communication;
b) a host computer system with machine readable instructions for operability for;
receiving, from a buyer-side user input/output device, return address information, store ID information and product ID information and electronically storing such information in a database record of unsatisfied demand;
providing, to a seller-side user input/output device, database reports of aggregate product demand information and/or remote retrieval of information other than the address from database records of unsatisfied demand for seller analysis of aggregate product demand;
receiving, from a seller-side user input/output device, store ID information, product ID information and new promotion information and electronically storing such information in a database record of modified supply;
transmitting, to a buyer-side user input/output device, new promotion information from database records of modified supply concerning a product in demand as a responsive communication;
c) computer instructions operably associated with the host computer system for;
generating, database reports of aggregate product demand information sorted by store ID and product ID or other key or key combination and/or permitting remote retrieval of information other than the address from database records of unsatisfied demand;
associating, store ID and product ID of a database record of unsatisfied demand with store ID and product ID of a database record of modified supply; and forward new promotion information to the associated return address of a buyer-side user input/output device as a responsive communication;
d) a seller-side user input/output device for;
receiving, from a host computer system, database reports of aggregate product demand information and/or requesting and retrieving information other than the address from database records of unsatisfied demand for seller analysis of aggregate product demand;
transmitting, to the host computer system, store ID information concerning the store of product availability, product ID information concerning a product in supply and new promotion information concerning a new promotion extended to the potential buyer.

10. A communication system as in claim 09 comprising a multiplicity of buyer-side user input/output devices and a multiplicity of seller-side user input/output devices.

11. A communication system as in claim 10 comprising at least 1,000 buyer-side user input/output devices and at least 4 seller-side user input/output devices.

12. A communication system as in claim 11 wherein the buyer-side user input/output device comprises a handheld device, PDA or cellular phone with imaging and/or text messaging capabilities, and;
wherein the return address comprises the phone number.

13. A communication system as in claim 12 wherein a buyer-side user transmits a proprietary code containing the store ID information and product ID information with the phone number to a host computer system.

14. A communication system as in claim 13 wherein the proprietary code may comprise a proprietary image.

15. A communication system as in claim 14 further comprising;
a) a buyer-side user input/output device for;
transmitting, to a host computer system, said proprietary code and phone number; with date queued information concerning date and time the product was queued for monitoring;
receiving, from the host computer system, said new promotion information; with related price information, store name information and product name information concerning the product in demand as a responsive communication;
b) a host computer system with machine readable instructions for operability for;
transmitting, to a buyer-side user input/output device, said new promotion information; with related price information concerning the initial observation of price, store name information and product name information from database records of modified supply concerning a product in demand as a responsive communication;
c) computer instructions operably associated with the host computer system for;
relating, date queued information to price schedule information, store ID information to store name information and product ID information to product name information, and;
forwarding, said new promotion information; with related price information, store name information and product name information to the associated return address of a buyer-side user input/output device as a responsive communication;
d) a seller-side user input/output device for;
transmitting, to a host computer system, said store ID information, product ID information and new promotion information; with price schedule information concerning all past and present stages of product pricing, store name information concerning the store outlet name and product name information concerning the product label.

16. A communication system as in claim 09 further comprising:
a) a buyer-side user input/output device for;
transmitting, to a host computer system, return address information for responsive communications, store ID information concerning the store of product observation and product ID information concerning a product in demand; along with demographic information concerning the potential buyer demographic or perceived value information concerning the potential buyer's assessment of the product in demand or product resolution information concerning the outcome of the buyer-side/seller-side communication for the product;
b) a host computer system with machine readable instructions for operability for;
receiving, from a buyer-side user input/output device, return address information, store ID information and product ID information; along with demographic information or perceived value information or product resolution information; and electronically merging such information in a database record of product R&D;
providing, to a seller-side user input/output device, database reports of aggregate product R&D information and/or remote retrieval of information other than the address from database records of product R&D for seller analysis of aggregate product R&D;
c) computer instructions operably associated with the host computer system for;
generating, database reports of aggregate product R&D information sorted by store ID and product ID or other key or key combination and/or permitting remote retrieval of information other than the address from database records of product R&D;
d) a seller-side user input/output device for;
receiving, from a host computer system, database reports of aggregate product R&D information and/or requesting and retrieving information other than address from database records of product R&D for seller analysis of aggregate product R&D.

17. A communication system as in claim 09 wherein the product ID information comprises a product code selected from the group SKU, UPC, EAN and GTIN.

18. A communication system as in claim 09 wherein the product ID information comprises a product code selected from the group consisting of VIN, MLS# and inventory numbers.

19. A communication system as in claim 09 wherein the buyer-side user input/output device comprises a handheld device, PDA or cellular phone with RFID (Radio Frequency ID) and/or text messaging capabilities, and;
wherein the return address comprises the phone number.

20. A communication system as in claim 09 wherein buyer-side users can monitor all records of unsatisfied demand for modified supply in one principle location free from seller spam.
